(19) United States
(12) Patent Application Publication
(10) Pub. No.: US 2005/0119103 A1
(43) Pub. Date: Jun. 2, 2005

(54) Centrifugal separator

(76) Inventor: Richard Hammerton Caulfield, Banjup (AU)

Correspondence Address: SUGHRUE MION, PLLC, 2100 PENNSYLVANIA AVENUE, N.W., SUITE 800, WASHINGTON, DC, 20037, US

(21) Appl. No.: 10/507,702

(22) PCT Filed: Mar. 12, 2003
(86) PCT No.: PCT/AU03/00287

(30) Foreign Application Priority Data
Mar. 14, 2002 (AU) PS1146
Nov. 28, 2002 (AU) 20029529962

(51) Int. Cl. B04B 1/04

(52) U.S. Cl. 494/67; 494/79

(57) ABSTRACT

A centrifugal separator (10) for separating separable constituents of a fluid to be separated, includes a body (12) rotatable about an axis, the body having a cavity (22) therein. A divider (28) divides the cavity into a first sub-cavity (24) arranged for fluid to flow in a direction having a radial component and a second sub-cavity (26) arranged for fluid to flow in a direction having a component that is towards the axis of rotation. An inlet (58) leads into the first sub-cavity at or near the axis of rotation of the body. A first outlet (52) is in communication with a settling region (34) of the cavity between or connecting the first sub-cavity to the second sub-cavity. A second outlet (50) leads from the second sub-cavity at or near the axis of rotation of the body.

### FIELD OF THE INVENTION

The present invention relates to a separator for separating separable constituents in a fluid.

### BACKGROUND OF THE INVENTION

It is known to use a centrifuge to separate suspended particles in a liquid as well as insoluble liquids. Most centrifuges rely on batch operation whereby a quantity of liquid for separation is inserted in a centrifuge, the centrifuge rotated separating the constituents in the liquid, the centrifuge stopped and the separated constituents removed.

Alternatively a screen or filter is used whereby particles of a size greater than the screen or filter are trapped within the centrifuge and particles of a lesser size pass through the screen or filter and are thereby separated. The problem with this type of separator is that the screen or filter can become clogged or blocked and must be regularly cleaned. A screen or filter can also impede flow.

The present invention provides a new centrifugal separator that is able to be operated either on a batch or continuous basis and does not require a screen or filter that may become blocked.

### SUMMARY OF THE INVENTION

According to the present invention, there is provided a centrifugal separator for separating separable constituents of a fluid to be separated, including:

a body rotatable about an axis, the body having a cavity therein;

a divider dividing the cavity into a first sub-cavity arranged for fluid to flow in a direction having a radial component and a second sub-cavity arranged for fluid to flow in a direction having a component that is towards the axis of rotation;

an inlet leading into the first sub-cavity at or near the axis of rotation of the body;

a first outlet in communication with a settling region of the cavity between or connecting the first sub-cavity to the second sub-cavity; and

a second outlet leading from the second sub-cavity at or near the axis of rotation of the body;

whereby in use, fluid to be separated enters the cavity via the inlet, rotation of the body and the fluid therein causes a centrifugal force to be applied to fluid flowing through the cavity, a first constituent of the fluid tends to collect in the settling region and a second constituent of the fluid tends to flow into the second sub-cavity, the second constituent in the second sub-cavity exits the cavity via the second outlet and the first constituent collected in the settling region exits the cavity via the first outlet.

Preferably a third sub-cavity connects the settling region to the first outlet. The third sub-cavily is arranged for fluid flow in a direction having a component that is towards the axis of rotation of the body. In a first embodiment, the first outlet is at or near the axis of rotation. Preferably the third sub-cavity is separated into a plurality of chambers by dividing walls, with each chamber extending towards the axis of rotation.

Preferably the size of the cavity decreases radially from the axis of rotation. Preferably the divider is shaped such that the shape of the first sub-cavity increases along the path of flow of fluid though the first sub-cavity. Preferably the size of the second sub-cavity decreases along the path of flow of fluid through the second sub-cavity. Preferably the divider is shaped to space the first sub-cavity from the second sub-cavity.

Preferably the first sub-cavity is provided with a plurality of radially extending fins. Preferably the first sub-cavity is divided into a plurality of chambers by the fins. Preferably the second sub-cavity is provided with a plurality of radially extending second fins. Preferably the second sub-cavity is divided into a plurality of chambers by the second fins. Preferably each first fin is integrally formed with a corresponding one of the second fins.

Preferably the separator includes a drive means for rotating the body. Preferably the speed of rotation of the body is controlled, whereby the extent of separation of the constituents can be controlled.

Preferably the separator includes a means for controlling the rate of flow of fluid to be separated in through the inlet. Preferably the separator includes a means for controlling the rate of flow of fluid from the first outlet. Preferably the separator includes a means for controlling the rate of flow of the fluid from the second outlet.

Preferably a shaft extends through the axis of rotation, the body arranged to be rotated by rotation of the shaft. Preferably the shaft extends through the body.

In a second embodiment, the settling region includes a collection region for holding the collected first constituent until it is removed via the first outlet. Preferably the collection region is spaced from the axis of rotation.

Preferably the body is substantially disc shaped. Preferably the body includes a first part and a second part. In a third embodiment, the parts are in the form of discs. Preferably the discs are separable. Preferably the first outlet is provided by a gap between the body parts when the parts are separated. Preferably the size of the gap is adjustable.

Preferably the divider is in the form of a radially extending planar disc. In one variation a circumferential region of the divider includes a first flange extending transversely to a radial line extending from the axis of rotation. Preferably the circumferential region includes a second flange extending transversely to the radial line from the axis of rotation and at an angle to the first flange greater than the angle of the first flange to the divider.

Preferably the inlet is provided with a raceway. Preferably the first outlet is provided with a raceway.

Preferably the separator includes a first collection means for collecting the first constituent as it exits the first outlet. Preferably the separator includes a second collection means for collecting the second constituent as it exits the second outlet.

In another variation, the collection region is contained within a bulb shaped portion of the body.

Preferably a separation zone precedes the collection region in the course of flow of fluid. Preferably the separation zone is divided into an inner separation zone and an outer separation zone by a parting means. Preferably the parting means is a circular knife. Preferably the collection region follows the outer separation zone in the course of flow of the fluid. Preferably a third outlet leads from the inner separation zone. Preferably the separator includes a third collection means for collecting the constituents exiting the third outlet.

Preferably the inlet extends the inside of the shaft. Preferably the second outlet extends into the inside of the shaft. Preferably the third outlet extends into the inside of the shaft.

Preferably the first outlet is closed and sealed by a seal in the gap between the parts of the body when the gap between the parts is closed. More preferably the first outlet is open when the gap between the parts is opened. Alternatively the gap is in communication with a valve/seal means. Preferably the first outlet is unsealed and open when the gap between the parts is moved to be partly closed. More preferably the first outlet is closed and sealed by the seal means when the gap between the parts is opened.

In the present specification, the term “fluid to be separated” is to be understood to mean an emulsion, suspension, mixture, or the like of constituents such as liquid and gas, liquid and liquid, gas and solid particles, liquid and solid particles, solid particles and solid particles, gas and gas or combinations thereof where the constituents are to be separated from one another. Typically, the constituents will be immiscible.

### BRIEF DESCRIPTION OF THE DRAWINGS

In order to provide a better understanding, a preferred embodiment of the present invention will now be described, in detail, by way of example only, with reference to the accompanying drawings, in which:

FIG. 1 is a cross-sectional side elevation of a centrifugal separator in accordance with the present invention;

FIG. 2 is a cross-sectional view of the section 2-2 of the separator of FIG. 1;

FIG. 3 is a cross-sectional view of the section 3-3 of the separator of FIG. 1;

FIG. 4 is an enlarged cross-sectional side elevation of a top portion of the separator of FIG. 1 showing an upper bearing;

FIG. 5 is an enlarged cross-sectional side elevation of a portion of FIG. 1 showing a lower bearing;

FIG. 6 is a cross-sectional side elevation of a preferred embodiment of the separator of the present invention;

FIG. 7 is a cross-section side elevation of a lower section of the separator of FIG. 6;

FIG. 8 is a plan view of the section A-A of FIG. 6 showing the lower section of FIG. 7;

FIG. 9 is a cross-sectional side elevation of an upper section of the separator of FIG. 6;

FIG. 10 is a plan view looking from the section B-B of FIG. 6 of the upper section of FIG. 9;

FIG. 11 is a cross-sectional view of a first set of paddles of the separator of FIG. 6;

FIG. 12 is a cross-sectional view of a divider of the separator of FIG. 6;

FIG. 13 is a cross-sectional view of a second set of paddles of the separator of FIG. 6;

FIG. 14 is a part cross-sectional side elevation of an alternative separator in accordance with the present invention;

FIG. 15 is a part cross-sectional side elevation of a further alternative separator in accordance with the present invention;

FIG. 16 is a part cross-section side elevation of yet another alternative separator in accordance with the present invention;

FIG. 17 is a side elevation of a separator housed in a chassis for use;

FIG. 18 is a cross-sectional side view of a separator mounted on a jack within the chassis of FIG. 17;

FIG. 19 is a part cross-sectional side elevation of the separator of FIG. 6 in use;

FIG. 20 is a part cross-sectional side elevation of yet another alternative separator in accordance with the present invention;

FIG. 21 is a cross-sectional side elevation of a further embodiment of a separator in accordance with the present invention;

FIG. 22 is a part cross-sectional side elevation of the separator of FIG. 21;

FIG. 23 is a part cross-sectional side elevation of the separator of FIG. 21, with an alternative seal of an outlet;

FIG. 24 is a part cross-sectional side elevation of the separator of FIG. 21, with another alternative seal of the outlet, in a closed configuration; and

FIG. 25 is a part cross-sectional side elevation of the separator and seal of FIG. 24, with the outlet in an open configuration.

### DETAILED DESCRIPTION OF THE INVENTION

Referring to FIG. 1, there is shown a separator 10 which includes a body 12 coupled to or integrally formed with a shaft 14. The body 12 and shaft 14 are rotatably mounted to a frame 16, with the shaft aligned with the axis of rotation.

The body 12 includes a first part 18 and a second part 20 secured together by bolts 19. Inside the body 12 is a cavity 22, notionally divided into a first sub-cavity 24 and a second sub-cavity 26 by a first divider 28, and a third sub-cavity 38 by a second divider 30. The first sub-cavity 24 is regarded as a part of the cavity 22 having a radially extending component. The second sub-cavity 26 is regarded as a part of the cavity 22 having a directional component towards the axis of rotation of the body 12 through which some of the separated fluid flows. The third sub-cavity 38 is regarded as a part of the cavity 22 also having a directional component towards the axis of rotation of the body 12 through which the rest of the separated fluid flows. Fluid will generally be travelling in a direction having a radial component when it is within the first sub-cavity 24 and in a direction having a component towards the axis of rotation when it is within the second sub-cavity 26 and third sub-cavity 38. Either between or coinciding with the first sub-cavity 24 and the second sub-cavity 26, is a settling region 34 that leads to a first outlet 52 via the third sub-cavity 38. The second sub-cavity 26 leads to an outlet 50 in line with the axis of rotation. Outlet 52 from the body is close to the axis of rotation.

An inlet 58 into the cavity 22 (and to the first sub-cavity 24) coincides with the axis of rotation.

The peripheral surfaces of the first and second sub-cavities 24 and 26 are somewhat conical and slope through the settling region 34 towards an entry to the third sub-cavity 38. This allows heavier constituents to flow down the slopes to the entry.

The divider 28 is shaped to minimise turbulence within the cavity 22 and to provide an expanding cross-sectional area as fluid flows through the first sub-cavity 24. These features encourage settling within the settling region 34 as fluid travels through the separator 10. The divider 28 is also shaped to provide a narrowing cross-sectional area as fluid travels through the second sub-cavity 26 towards the axis of rotation, which also encourages settling.

A plurality of fins 32 and 36 are provided in the first and second sub-cavities 24 and 26. These fins 32 and 36 are preferably integrally formed such that a single fin 35 forms first 32 and second 36 fins within the first and second sub-cavities 24 and 26, respectively. The fins 35 are shown extending radially in FIG. 2. The fins 35 partition the first sub-cavity into a plurality of first channels 70 and the second sub-cavity into a plurality of second channels. They also impart rotational velocity to fluid travelling through the first sub-cavity 24 while also further minimising turbulence of the fluid by reducing slip in the fluid. When the fluid enters the second sub-cavity 26, the fins 35 recover the rotational velocity of the fluid passing through the second channels thereby conserving energy. As a result, a large portion of the energy required to rotate fluid at a high rotational velocity is recovered, so that the overall energy required to be input is less than would be required by a screen or filter centrifuge.

The third sub-cavity 38 is formed of a plurality of passageways 72 in between islands 74. Each of the passageways 72 is able to recover rotational energy imparted as the constituent flows through the third sub-cavity 38 to the first outlet 52. This further contributes to the conservation of energy.

The shaft 14 is coupled to a spindle 44 around which a belt can be placed. A motor rotates the belt and thus the separator 10.

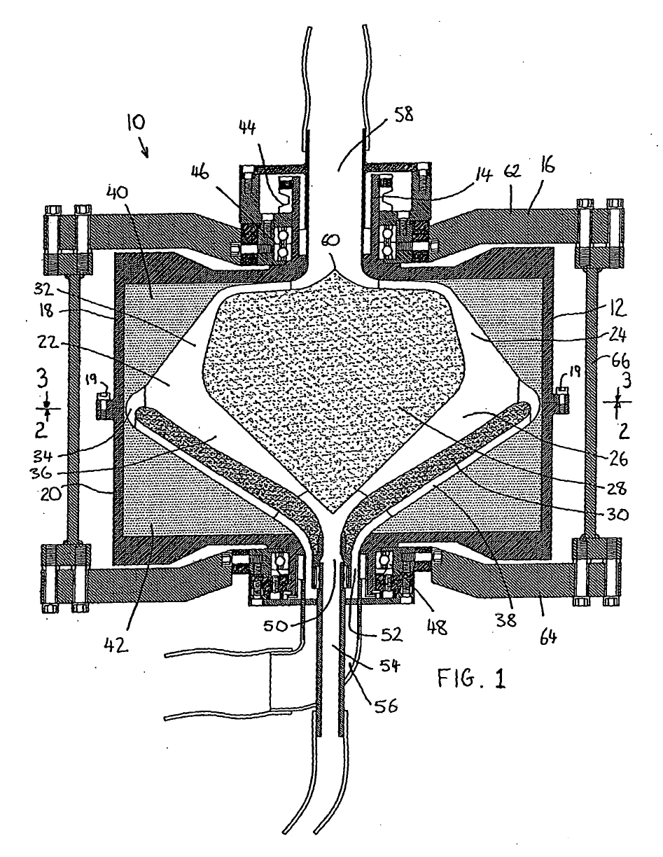

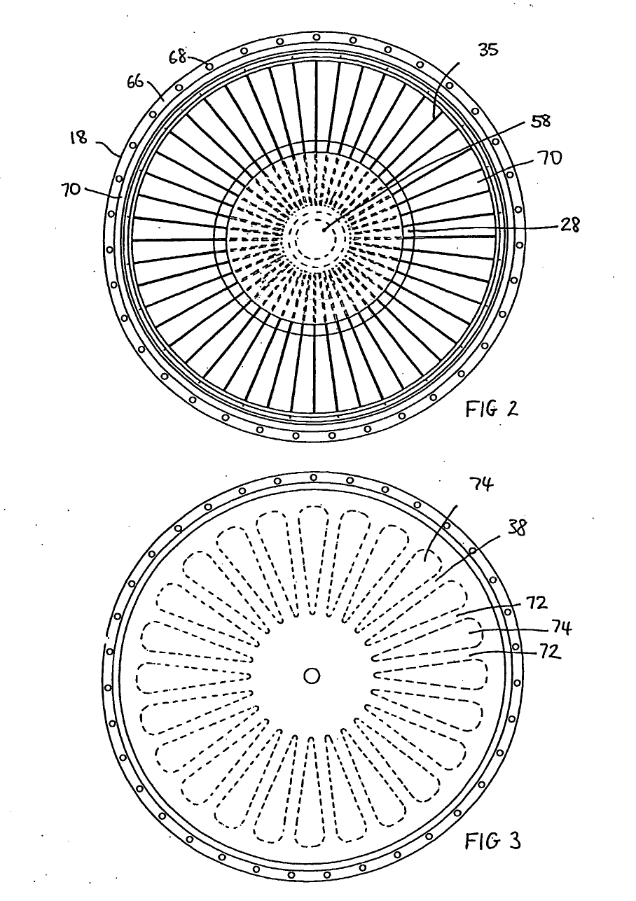

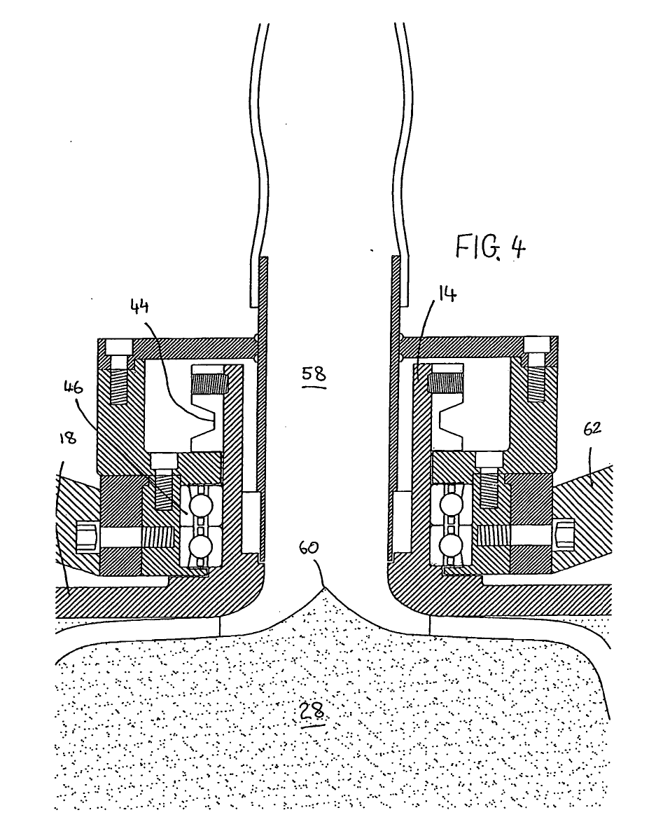

Referring to FIG. 4, the shaft 14 and upper portion of the body 12 is rotatably coupled to a top member 62 of the frame 16 by bearings 46. The top member 62 is spaced from a bottom member 64. Separating the top member 62 and bottom member 64 is a cylindrical cage member 66 which provides a protective barrier around the rotating body 14. The rotating body 14 can be rotating at high velocities. The frame 16 is not only used for mounting purposes, it is also used for safety purposes. The inside of the cage member 66 my be lined with a thermally resistant material, which may act as a break if the body broke free.

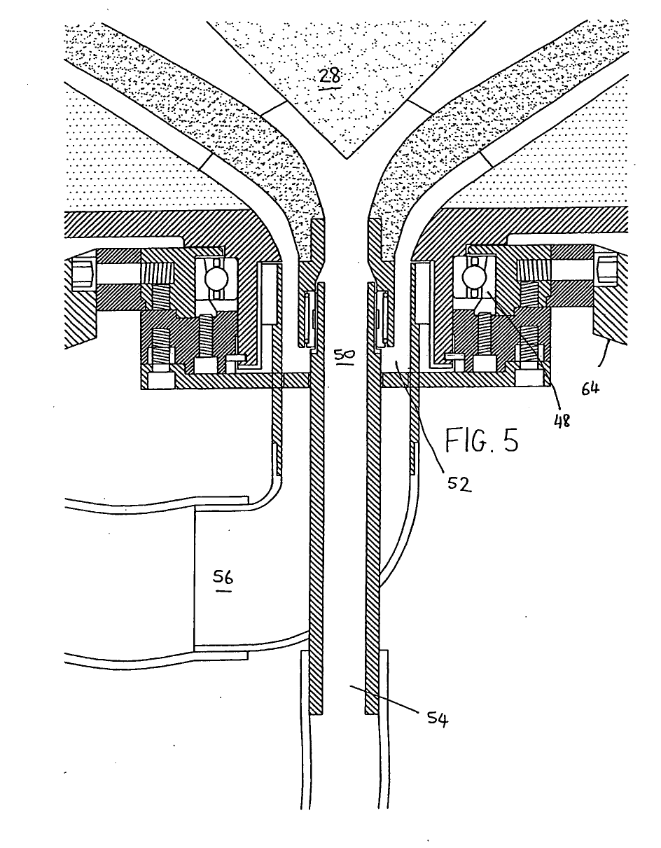

Referring to FIG. 5, a bottom of the separator body 12 is coupled to the bottom member 62 by a bearing 48.

The divider 28 may be formed of a very lightweight material so that it has a specific gravity less than the fluid flowing through the separator 10. This will urge the divider 28 to remain in-line with the axis of rotation of the body 12. The cavity 22 can be formed by molding the shape of the inside of the body 12 to the desired shape of the inside of the cavity 22. Preferably the shape will be molded from a material 40 and 42 having a specific gravity greater than the fluid to be separated.

The method of use and operation of this embodiment of the present invention will now be described with reference to the accompanying drawings.

The fluid to be separated contains at least a first constituent and a second constituent. The fluid to be separated enters the inlet 58. A swirl device may be provided at the inlet 58 to provide the fluid to be separated with an initial rotational impedus. The fluid to be separated is divided by a point 60 of the divider 28. The fluid to be separated travels substantially radially at first within each of the passages 70 between the first fins 32 where it increases in rotational velocity as it moves radially through the first sub-cavity 24.

The fluid to be separated then enters an expanding portion of the first sub-cavity 24. Due to centrifugal force applied to the rotating fluid to be separated, a high artificial gravity is experienced by the fluid to be separated. Due to the artificial gravity and assisted by the turbulence minimising features described above, particles of a higher specific gravity will tend to move along the peripheral surface in the settling zone 34, into the entry to the third sub-cavity. Particles with a higher specific gravity are regarded as the first constituent and will tend to congregate and move towards the extreme most radial perimeter within the settling zone, ie. the entry to the third sub-cavity. The second constituent with a lesser specific gravity will tend to “float” towards the axis of rotation. This second constituent then moves into the second sub-cavity 26 and travels through the second channels between the fins 36 moving closer towards the axis of rotation. The first constituent enters the opening of the passageways 72 in the third sub-cavity and travels through passages 72 back towards the axis of rotation. As the first constituent and the second constituent travel towards the axis of rotation, rotational energy is recovered by fins 26 or islands 74. The first constituent then exits the first outlet 52 and travels into a pipe 56 where it is then taken away. The second constituent exits the separator by the second outlet 50 where it travels through pipe 54 and is then taken away.

The fluid to be separated is preferably pressure fed into the separator 10 to assist in the flow through of the constituents. In particular, the separated first constituent can become highly viscous or paste-like depending on its nature, so pressurisation assists to avoid clogging. In addition, suction could be applied to the outlet 52.

Depending on the speed of rotation, the degree of separation of the constituents can be controlled. Furthermore, separated second constituent exiting pipe 54 can be recycled through the separator or another separator to remove a further amount of first constituent, if any, remaining in separated fluid. Equally, the separated first constituent could be recycled to further refine the degree of separation.

Furthermore, depending on the amount of first constituent in the fluid to be separated, the size of the first and second sub-cavities and settling region may be varied accordingly. If only a very minor amount of second constituent is to be separated, the size of the passages 72 can be diminished so that this passageway does not become flooded with the first constituent.

Additional control can be provided by controlling the flow of fluid to be separated entering the inlet 58 by using for example a valve. Controlling the flow of separated fluid including the second constituent exiting by the pipe 54 can be controlled such as by using another valve. Furthermore, separated first constituent exiting by pipe 56 can also be controlled by, for example using yet another valve. Using these various control mechanisms, the degree of separation of constituents in the fluid to be separated can be further controlled.

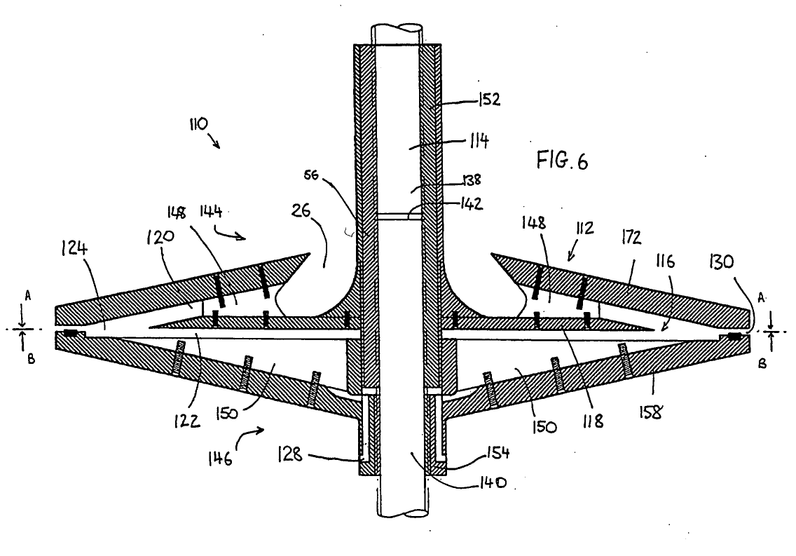

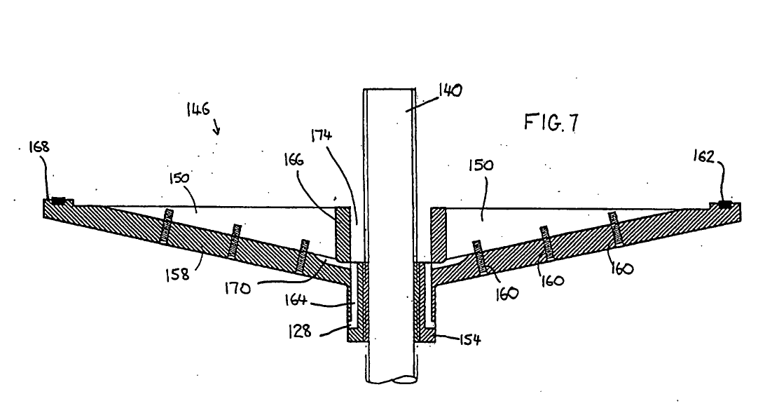

Referring to FIG. 6 there is shown another embodiment of the present invention, with a separator 110 which includes a body 112 rotatably mounted to a shaft 114. Preferably the shaft 114 is split into a first section 138 and a second section 140 with a gap 142 between the two section 138 and 140. Furthermore the shaft is preferably hexagonal in cross-section so as to be keyed with receiving coupling collars 152 and 154 of the body 112.

The body 112 is formed of a first part in the form of a disc 172 and a second part in the form of a disc 158. The discs 172 and 158 taper towards one another along a radial line extending from the shaft 114. The disc 172 is fixably, slidably coupled to the shaft section 138 by coupling collar 152. The disc 158 is fixably, slidably coupled to the shaft section 140 by coupling collar 154. A cavity 116 is provided within the body 112 between the discs 172 and 158. Extending into the cavity 116 from the coupling collar 152 is a divider 118 in the form of a planar disc having a circumferential edge tapering to a point. The tapering of the first and second discs also causes the cavity 116 to taper radially away from the shaft 114. The divider 118 divides the cavity 116 into a first sub-cavity 120, and a second sub-cavity 122, with a collection region 124 joining the first sub-cavity 120 to the second sub-cavity 122. The collection region 124 commences from the circumferential edge of the divider 118.

An inlet 126 is provided into the first sub-cavity 120. The inlet 126 may by in the form of a raceway into which a pipe can extend to insert fluid to be separated into the separator 16. Other forms of inlet may be provided as would be suitable for the particular application of the separator 110. One alternative is described below in relation to FIGS. 21 to 25.

A first outlet 130 leads from the collection region 124. The outlet 130 is provided by a gap between each of the discs 172 and 158. A second outlet 128 leads from the second sub-cavity 122 out of the body 114 of the separator adjacent the shaft 114.

It is preferred to have the circumferential edge of the divider 118 as far away from the shaft 114 as possible. Although, the distance of the edge from the outlet 130 may provide a method of controlling the amount of separation occurring.

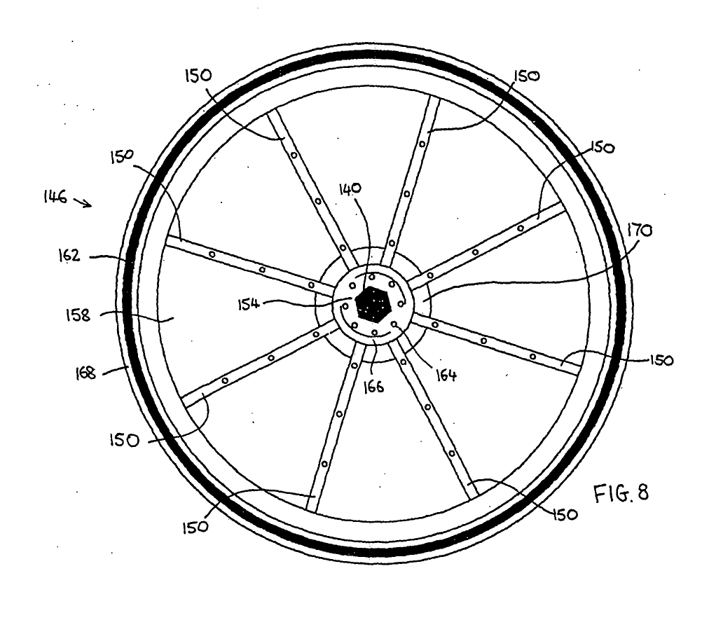

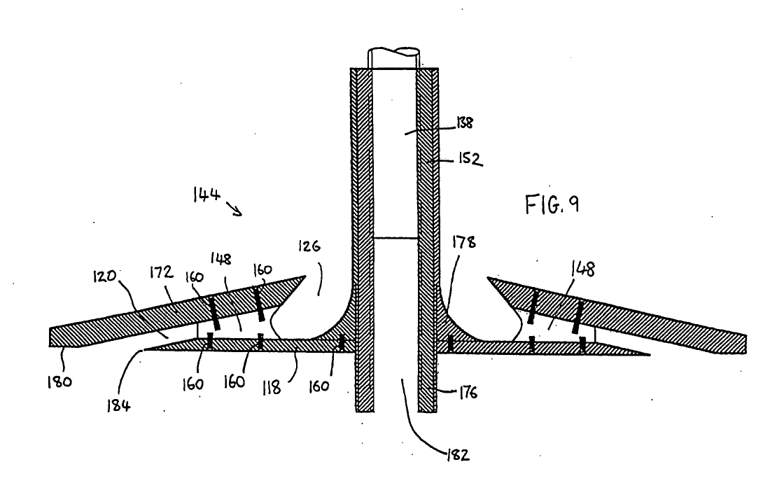

Referring to FIGS. 7 and 8, a lower part 146 of the separator 110 is described in more detail. The second section 140 of the shaft 114 can be seen extending through coupling collar 154. Extending upwardly from the coupling collar 154 is another collar 166. The inside surface of the collar 166 is spaced from the second shaft section 140 to form a socket 174. Within an inside surface of the second disc 158, near the shaft 114, is an annular funnel 170. The funnel 170 extends underneath the collar 166 and leads to a plurality of channels 164 that form the second outlet 128. Radially extending from the collar 166 are a plurality of baffles 150 (similar to the fins of the previous embodiment). Each of the baffles 150 tapers along its length away from the shaft 114 so as to conform with the inside surface of the second disc 158. Each of the baffles 150 is fixed to the second disc 158 by grub screws 160. At a perimeter of the second disc 158 is a raised portion having a surface 168. The surface 168 is perpendicular to the length of the shaft 114. A corresponding surface 180 is provided on the first disc half 172 as shown in FIG. 9. An O-ring 162 extends around the raised portion so that it protrudes from the surface 168 and is recessed within the raised portion.

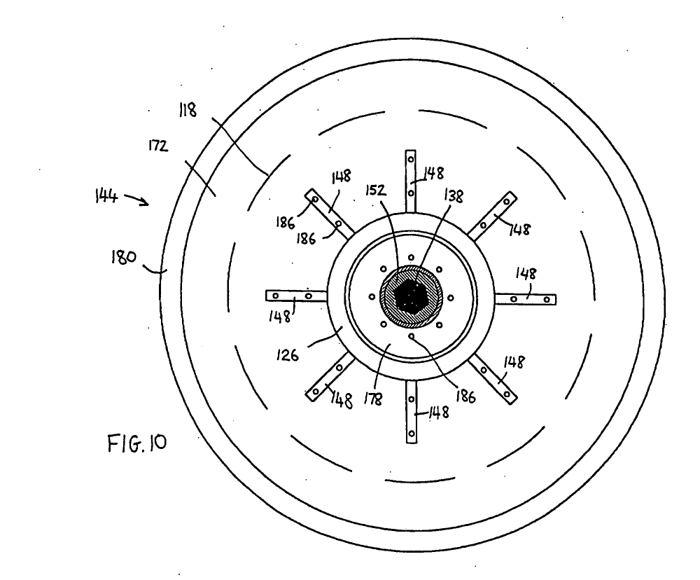

Referring to FIGS. 9 and 10 an upper part 144 of the body 112 is shown. A first section 138 of the shaft 114 is shown coupled to the coupling collar 152. The shaft section 138 extends part way through the inside of the collar 152. A shaft socket 182 formed in the lower part of the collar 152. The shaft socket 182 is for receiving a portion of the second shaft section 140 that protrudes past the second half 146 of the body 112 as mentioned in relation to FIG. 8. When the first half of the body mates with the second half of the body a separation gap 142 is provided between each of the shaft sections 138 and 140. A gap is also formed at the first outlet 130 between surfaces 168 and 180. The degree of insertion of the second shaft section 140 into the shaft socket 178 can be adjusted, which determines the size of the separation gap 142, the size of the second sub-cavity 122 and importantly the distance between the surfaces 168 and 180 and thus the size of the first outlet 130.

Coupled to the socket section of the coupling collar 152 is the divider 118. A diverter 178 is attached to the coupling collar 152 for diverting fluid to be separated into the first sub-cavity 120 through the inlet 126. A series of holes 186 extend into the diverter 178 for attaching the divider 118 by grub screws 160. Extending between the first disc 172 and the divider 118 are a series of radially extending baffles 148. The baffles 148 have holes 186 for receiving grub screws 160 to attach to the divider 118 and the first disc 172.

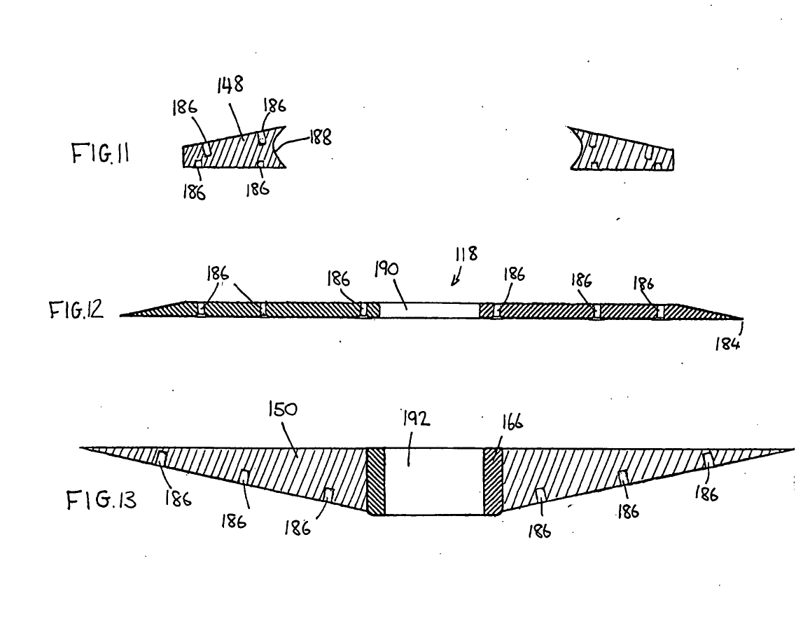

The baffles 148 are shown in isolation in FIG. 11, with each baffle 146 being shaped to sit between the first disc 172 and the divider 118. A curved edge 188 is shown. The curved edge 188 minimises turbulence in the fluid to the separated as it enters through the inlet 126.

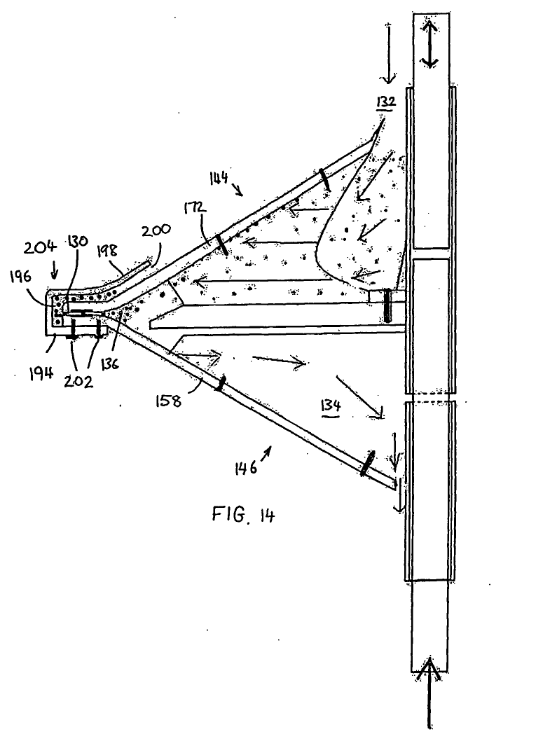

The divider 181 is shown in isolation in FIG. 12. The circumferential edge 184 is indicated. A hole 190 is for the divider 118 to slide over the coupling collar 152.

A set of second baffles 150 is shown in FIG. 13 attached to the collar 166, which has a hole 192 within forming the socket 76 and for receiving the coupling collar 154.

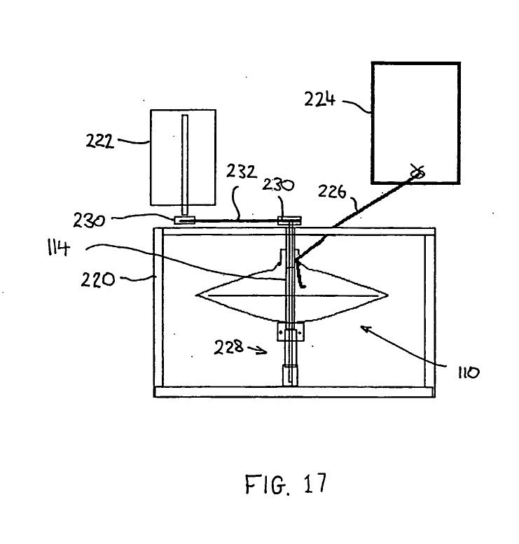

Referring to FIG. 17 an example of an assembly for operating the separator 110 is shown. The assembly includes a frame 220 within which is housed the separator 110. The separator 110 is orientated so that the shaft 114 extends vertically with the inlet 126 situated above the second outlet 128. It is noted that the separator need not operate in that orientation, although it would generally be preferred to operate in this orientation. The separator shaft 114 is mounted to the frame 120 by a bearing. A pulley or spindle 230 is coupled to the shaft 114. The bottom of the shaft 14 sits on a thrust bearing which in turn sits upon a jack 228. The jack assembly 228 is able to raise the second section 140 of the shaft and thus alter the size of the separation gap 142 and thus the distance between the first half 144 of the body in relation to the second half 148 of the body and in particular the gap that forms the first outlet 130. The pulley or spindle 230 is connected via a drive belt 232 to another pulley 230 mounted on the end of a motor 222. Accordingly the motor 222 is able to rotate the shaft 114 and thus the body 112 of the separator 110. Controlling the speed of the motor controls the rotation of the separator 110. A feed tank 224 feeds fluid to be separated into the separator into the inlet 126 of the separator 110 via a pipe 226. A collection means (not shown) is provided at each of the outlets.

It will be appreciated that a variety of assemblies may be used, depending upon the particularly application of the separator.

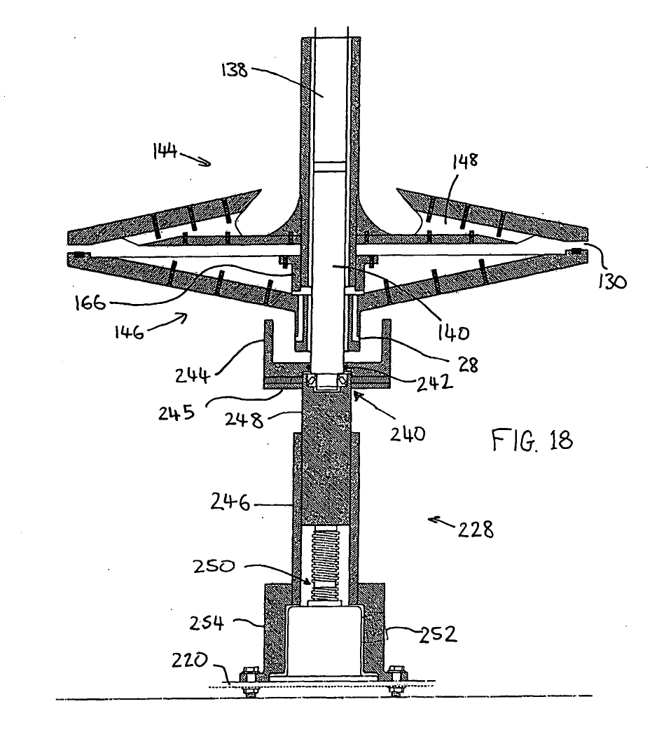

Referring to FIG. 18, the jack assembly 228 is shown in more detail. It can be seen that the second section of the shaft 140 has a spigot projecting into a thrust bearing 240. A roller bearing 242 provides additional stability to the shaft section 140. A mounting plate 245 houses the bearings 240 and 242. The mounting plate 245 sits on a column 248, which is slidable within a sleeve 246. The sleeve 246 is coupled to a base 254, which is in turn bolted to the frame 220. A threaded extendable/retractable member 250 of a jack is able to raise or lower the column 248 within the sleeve 246 by rotating a crank coupling 252 (using a cranking handle) geared to the member 250. A collection means 244 extends from a top of the mounting plate 245 to collect fluid exiting the second outlet 128. It can be seen that if the shaft section 138 is not permitted to move vertically then the adjustment of the jack will cause the shaft section 140 to move relative to the shaft section 138, which in turn adjusts the distance between the first part 144 and second part 146 of the separator and in particular adjusts the gap which forms the first outlet 130.

Also in this figure, it can be seen that the baffle 148 extends further towards the collection region 124 than the baffle 148 shown in FIG. 6. Also in this embodiment minor variations are made to the collar 166.

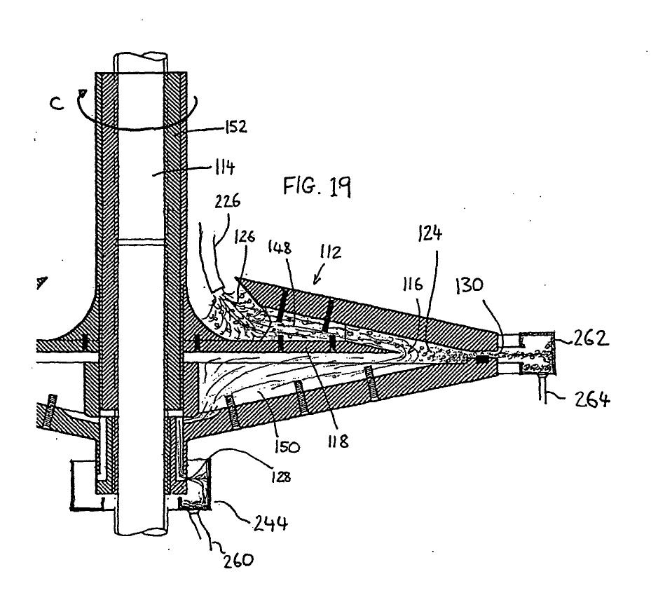

Referring to FIG. 19, the method of use and operation of this embodiment of the present invention is described. Fluid to be separated enters the inlet 126 of the separator 110 from pipe 226.

The shaft 114 is rotated as indicated by the arrow C. Fluid entering the cavity encounters baffles 148 and is imparted with rotational momentum as the fluid moves towards the collection region 124. The baffles 128 impart angular velocity to the fluid and serve to reduce turbulence in the fluid, which otherwise slips against the rotating body and shears causing turbulence. As the fluid reaches the end of the divider 118 particles entrained within the fluid have centrifugal force exerted on them and tend to collect in the collection region 124 under what is in effect high artificial gravity. The particles tend to settle over the first outlet 130 within the collection region 124. Depending on the operation required, the particles are collected or allowed to exit the separator via the outlet 130 continuously or in batches. Fluid is more readily able to make a sharp turn around the circumferential edge of the divider 118 and travel into the second sub-cavity 122. Fluid tends to do this rather than particles due to the high centrifugal forces which cause particles (or fluid) having a higher specific gravity to settle in preference to fluid or other particles having a lower specific gravity. It is also noted that in the collected region 124 it is desirable to keep turbulence to a minimum to allow the specific gravities to sort the particles and fluid.

Under the influence of normal gravity or back pressure or suction, fluid having a lower specific gravity tends to move through the second sub-cavity 122 past the baffles 150 towards the outlet 128. As the fluid substantially devoid of particles moves towards the shaft it releases rotational energy to the baffles 150 so that energy is conserved by the separator and fluid exiting the second outlet 128 is less turbulent. Fluid is then able to exit the second outlet 128 where it is collected by a collection means 244. The collection means 244 may simply be in the form of an annular cup, which drains via a pipe 260.

With a continuous flow of fluid to be separated into the separator, continual depositing of particles occurs. Particles collecting in the collection region 124 are compressed together and slowly moves through the outlet 130.

Smaller particles will tend to displace fluid between larger particles as they settle. The displaced fluid improves lubricity between particles and effectively jostles them further assisting the compacting process. The gap between the surfaces 168 and 180 controls the size of the outlet 130 and thus the rate at which particles can exit. Generally this gap will be very small. Particles may be in a thick paste like state with minimal fluid and will ooze through the outlet 130. It is important to control the rate of outlet of the particles through the outlet 130 to minimise turbulence within the collection chamber 124 and allow settling of the particles. This may require the size of the separation gap 142 being varied through phases to allow adequate collection of particles before their release through the outlet 130. Once released due to the high centrifugal force exerted on the particles they will tend to fly free where they may then be collected within a C-shaped annular collection means 262 and then drained by an outlet pipe 264 or be disposed of in some other manner.

In some instances the particles are to be kept and the fluid is to be discarded and in other instances the particles discarded and the fluid is kept and in yet other cases both the fluid and particles are kept depending on the application of the separator. The output of the first and second outlets can be dealt with appropriately.

It is noted that when describing the operation of the separator the term “particles” is used to refer to solids, liquids or gasses that have higher specific gravity or higher settling velocity than the other constituent of the fluid to be separated, which may also be a solid, liquid or gas. In some instances there may also be a carrier fluid, particularly where solid particles are to be separated from other solid particles each having different specific gravities or particle sizes. It is noted that separation can be conducted by specific gravity or by particle mass or by particle size. The speed of rotation of the separation is believed to control the type and rate (effectiveness) of separation. The flow rate of fluid into or out of the separator can also be controlled, which can also control the rate of separation.

Referring to FIG. 14, another alternative collection means 204 is shown in schematic form. The collection means 204 is in the form of a member 194 which is a grotesque J-shape in cross section. The member is coupled to the outside of the second disc 158 by grub screws 202. A gap 196 is provided between the outlet 130 and the member 194. Also, the gap 196 extends around the back of the J and is curved to leave a gap 200 between the member 194 and the disc 172. This allows particles that have exited the outlet 130 to collect within the gap 196 and build up. The gap 196 can then be drained via a raceway.

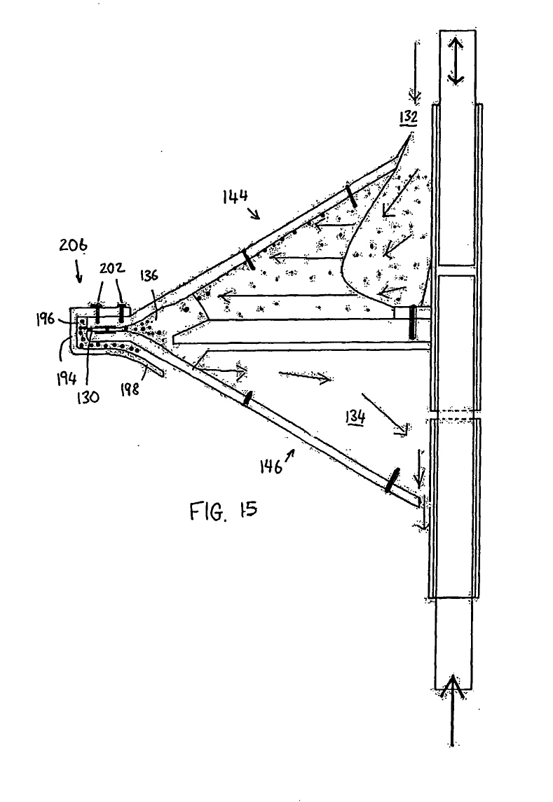

Referring to FIG. 15, another schematic variation of a collection means is shown. In this embodiment, the member 194 is affixed to the disc 172 by the grub screws 202. Particles that have exited the outlet 130 accumulate in the gap 196, where they accumulate and flow down the back 198 of the J member 194 and then drip under the influence of gravity into a collection tray.

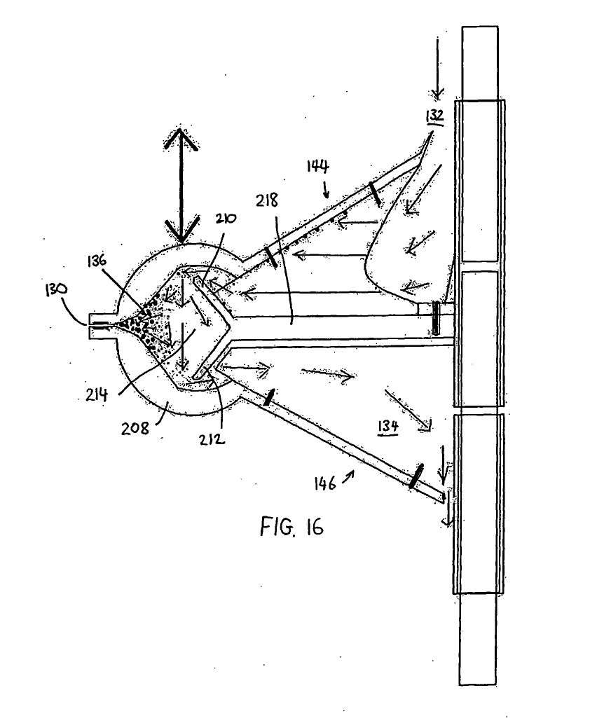

Referring to FIG. 16, an alternative separator is shown with an enlarged collection region 214. In this case the discs 172 and 158 together have a bulb portion 108. The inside of the bulb portion 208 serves to enlarge the collection region 214. In addition, the divider 118 is provided with a first flange 210 and a second flange 212 which extend in opposite directions at an angle of approximately 60° to the plane of the remainder of the divider 118. Both flanges 210 and 212 provide a fork-like appearance to the circumference of the divider 118. Each of the flanges 210 and 212 end in a ridge, around which the fluid to be separated must travel. This assists in separation of the particles from the remainder of the fluid. It can therefore be seen that fluid entrained with particles 132 that enters the inlet and is then subjected to centrifugal force by the separator tends to have particles 136 collect within the larger collection region, which tapers towards the second outlet 130. Fluid substantially devoid of particles 134 may then leave via the second outlet. This apparatus can assist where the specific gravity of the particles is similar to the fluid and where the particles would tend to float within the collection region rather then being separated according to their specific gravity. In this case they have a greater time to dwell in the collection region and can therefore clump together. Clumping tends to reduce their tendency to float or hover in the collection region 124. They will therefore effectively “sink” into the mass of the rest of the particles which will then tend to continue to compact them together as they move towards the outlet 130.

Increasing the size of the collection region 24 can affect the time particles have to settle. This therefore provides a means of controlling the particle settling time.

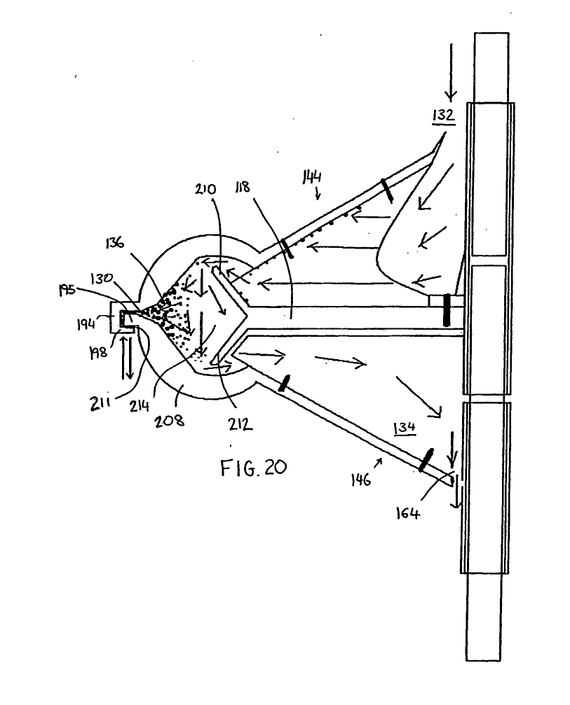

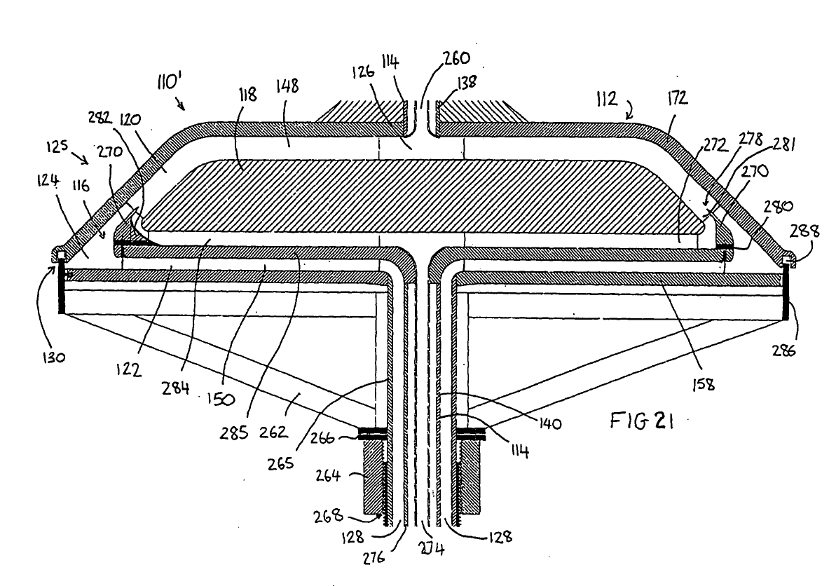

Referring to FIG. 20, an alternative to the separator of FIG. 16 is shown. In this case, the outlet 130 is covered by member 194, J shaped in cross section, which loops over to overlap with a lip 195 on the other side of the outlet 130. The overlapping of member 194 has the advantage of providing a seal between the inwardly extending part 198 of the member 194 and the lip 195 when the upper and lower parts are separated somewhat. In some cases, particularly when the speed of rotation is great (or the diameter of the discs are large) hydrostatic forces can force the seal 162 to fail. In this case the forces pressuring the discs to part only serve to assist in sealing between 195 and 198.

The build up of collected particles 136 can be released in batches, either via outlet 130 or by flushing out of outlet 164.

It can be advantageous to seal the inlet and outlets from the atmosphere so that the cavity is completely full of fluid in use. Pressurising the fluid flow can further assist this.

Referring to FIG. 21, there is shown another embodiment, separator 110′. The separator 110′ has many similar features to the separator 110. Like numerals represent like features. The following description concentrates on the differences between separator 110 and separator 110′. Separator 110′ includes a body 112 rotatably mounted to a shaft 114. Shaft 114 is split into a first section 138 and a second section 40. The majority of the body 112 is disposed between the two section 138 and 140.

The body 112 is formed of a first bowl shaped disc 172 and a second planar disc 158. A part of the disc 172 tapers towards disc 158. The disc 172 is coupled to the shaft section 138. The disc 158 is coupled to the shaft section 140.

A cavity 116 is provided within the body 112 between the discs 172 and 158. Extending into the cavity 116 is a divider 118 in the form of a thick planar disc having a tapering circumferential edge substantially parallel with the tapering part of the disc 178. The divider 118 divides the cavity 116 into a first sub-cavity 120, and a second sub-cavity 122, with a collection region 124 joining the first sub-cavity 120 to the second sub-cavity 122. A second divider 285 extends radially from the axis of rotation between the first divider 18 and the second disc 158. A third cavity 284 is provided between the first divider 118 and the second divider 285. The second cavity 122 is defined by the void between the second divider 285 and the disc 158.

An inlet 126 is provided into the first sub-cavity 120 from a pipe or channel 260 within the inside of the shaft section 138. A separation zone 125 is defined between the commencement of the tapering circumferential edge of the divider 118 and the second disc 158. A first outlet 130 leads from the collection region 124. The outlet 130 is provided by a gap between each of the discs 172 and 158. The outlet is shown to be closed by a seal 286. A second outlet 128 leads from the second sub-cavity 122. The outlet 128 is formed by a sleave 165 over the shaft section 140. A third outlet 274 leads from the third cavity 284. The third outlet is in the form of tube or channel extending through the inside of the shaft section 140. An entry 281 to the third cavity 284 leads from the separation zone 125. The second divider 285 includes a parting means in the form of a circular knife 270. The knife 270 has a blade tip 278 pointing towards the direction of flow of fluid in the collection region 116. This will part the flow of fluid, with fluid closer to the axis of rotation entering the third cavity 284, through the entry 281, and fluid further away from the axis of rotation entering the second cavity 122 or collection region 124.

The position of the blade tip 278 can be moved by placing more or less circular shims 280 between the knife 270 and the planar body of the second separator 285.

The second disc 158 is fixed in relation the first disc 172. An A-frame (in cross-section) support 262 is longitudinally movable in relation to the shaft 114. The support 262 abuts a thrust washer 266 which in turn abuts an internally threaded collar 264. The collar 264 is akin to a nut that screws onto a threaded bolt, with the equivalent of the bolt being an external thread 268 located on the sleave 265. By rotating the collar 264 the position of the support 262 and thus the disc 158 may be altered. Alternative means for moving the support 262 can be provided as appropriate. Such alternatives may include mechanised or hydraulic means that can move the support 262 while the separator 110′ is rotating.

Extending between the first disc 172 and the divider 118 are a plurality of radially extending baffles or fins 148 that follow the contour of the first cavity 120. Extending between the first divider 118 and the second divider 285 are a plurality of radially extending baffles or fins 272 that follow the contour of the third cavity 284. Extending between the second divider 285 and the second disc 158 are a plurality of radially extending baffles or fins 150 that follow the contour of the second cavity 122.

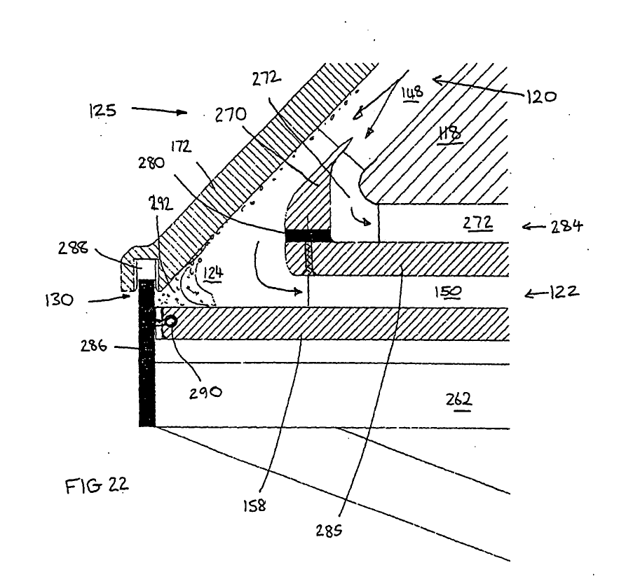

Referring to FIG. 22, in use particles under the influence of centrifugal forces are driven towards the inside surface of tapered portion of the first disc as they travel through the separation zone 125. The particles 292 are shown collecting the in the collection region 124. In this embodiment the separator is configured to collect particles in a batch mode. Once enough particles are collected in the collection region, or the batch of fluid has been processed, the outlet 130 may be opened to allow the particles to be removed. The flow of fluid from the second outlet 128 can be used to detect the filling of the collection region 124.

The seal of the outlet 130 is in the form of a circular sealing member 286 that is coupled to the perimeter of the second disc 158 by a flexible bridging member. The sealing member 286 is coupled to the support 262. The sealing member 286 may be inserted in a circular recess 288 provided in outer end region of the first disc 172 by moving the support 262. In doing so, the bridging member will flex. The sealing member 286 may be in the form of a reinforced rubber ring having an oversized insert 290 at the inner edge of the bridging member for threading in a keyway of the second disc 172. The ring may be fixed to the support 262 by an adhesive and or mechanical means. The sealing member 286 forms a seal at the outlet 130 when inserted in the recess 288.

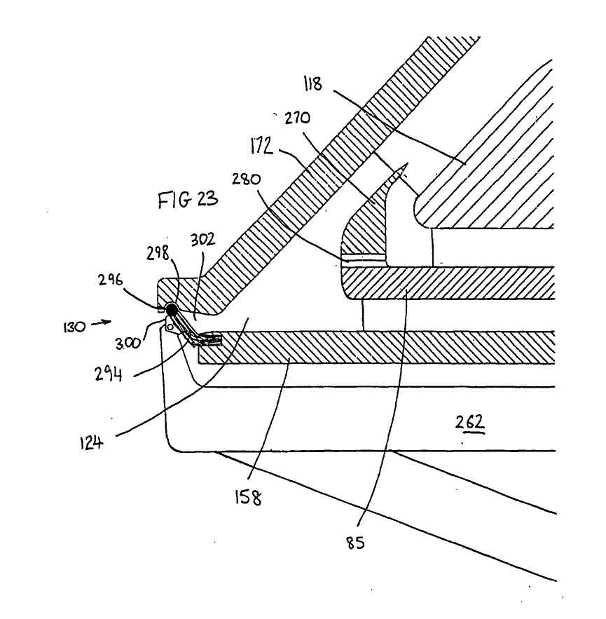

Referring to FIG. 23, an alternative form of outlet 130 is shown. The seal of the outlet is in the form of a flexible, resilient, member 294 coupled to the second disc 158. The member 294 normally extends substantially parallel to the second disc 158. The member 294 has a head 296. A correspondingly shaped (semi-circular in cross-section) recess 298 is provided in the end region of the first disc 172. The support 262 includes a positioning tip 300. When the support 262 is moved towards the second disc 158, the tip 300 engages with and pushes the member 294 towards the recess 298. This closes the outlet 130 until the head 296 is tightly pushed into the recess 298, whereupon the outlet 130 is sealed. If the support 262 is moved away from the second disc 158, pressure on the head is released and the seal ends. The outlet opens as the member 294 returns to its normal position. Any particles settled in the collection region 124 may be removed. If the particles are tightly packed they may not be inclined to exit. The passage 302 through the outlet 130 may be tapered to expand in volume radially to assist in removal of collected particles.

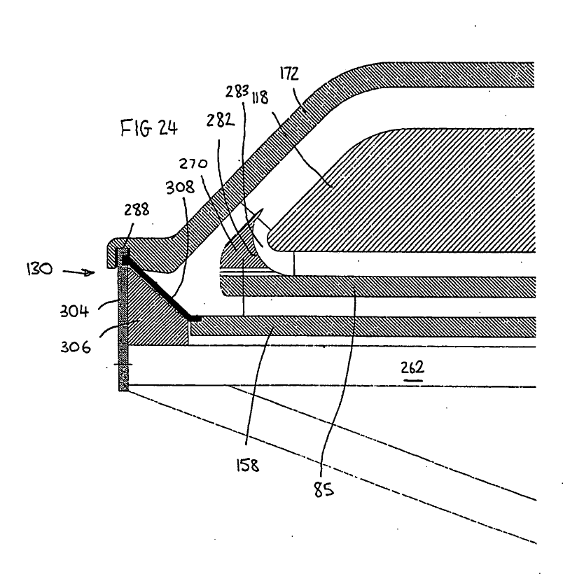

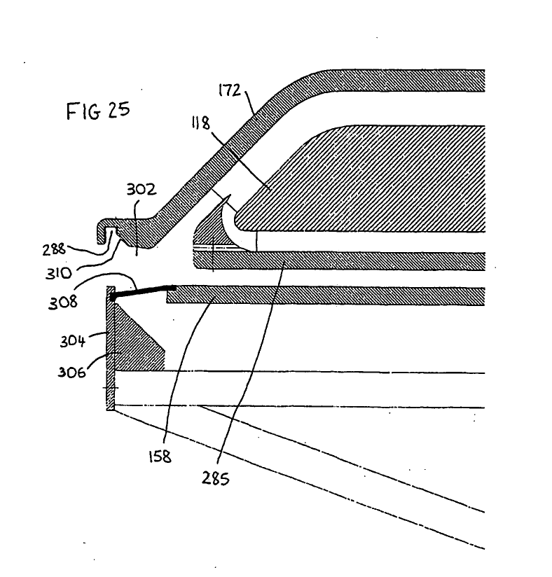

Referring to FIGS. 24 and 25, another alternative form of outlet 130 is shown. The seal of the outlet is also in the form of a flexible member 308 that extends between the second disc 158 and a circular flange 304. The flange 304 extends from the support 262 toward the first disc 172. A backing member 306 supports the back of the member 308 when the outlet is closed. The backing member 306 is in the form of an inclined ring fixed to the support 262 and flange 304. A circular recess 288 provided in outer end region of the first disc 172 for receiving tip of the flange 304. A surface 310 is angled to abut the member 308 when the outlet is fully closed to form a seal between the first disc 152 and the member 308.

As the support 262 is moved towards the second disc 158, the tip of the flange 304 engages with recess 288. This closes the outlet 130 with the member 308 providing a seal. The member 308 is supported by the backing member 308. If the support 262 is moved away from the second disc 158, the flange 306 parts from the recess 288, the backing member 306 parts from the back of the member 308 and the member 308 moves away from the surface 310. The outlet opens as the member 308 continues to move away from the surface 310. Any particles packed/settled in the collection region 124 may be removed. The passage 302 through the outlet 130 is tapered to expand in volume radially to assist in removal of collected particles.

The inner layer of fluid parted by the parting means 270 may not be totally devoid of particles. If this is the case particles may be inclined to settle if the dwell time of the fluid flow is sufficient, such as in places where the flow is subject to eddying. In FIG. 21 on the right hand side the parting means 270 provides a sharp bend in the passage into the third cavity 284. On the left hand side the drawing is modified to show an arrangement to stop settling of particles from the fluid that has been parted from the rest of the fluid flow. If particles were allowed to settle, then the build up could provide clogging or blockage of the flow. The arrangement to prevent settling of particles here is shown in more detail in FIG. 24.

At a bend 283 in the passage between the outermost circumferential tip of the first divider and the parting means 270, the passage is narrowed by providing a curved surface 282 of the parting means 270 closer to the first divider 118 than the gap between the knife tip and the divider 118 and the thickness of the third cavity 284. This will cause the fluid flow to speed up as it moves though a reduced volume. Due to the increase in velocity of the fluid (jetting) any particles remaining in the fluid will be less inclined to settle.

The method of use of the separator 110′ is similar to separator 110. Fluid to be separated is enters the inlet 126. The shaft 114 is rotated. Fluid entering the cavity encounters baffles 148 and is imparted with rotational momentum as the fluid moves radially though the first cavity 120. As the fluid reaches the tapered part of the divider 118 particles entrained within the fluid have centrifugal force exerted on them and tend to layer on the inner surface on the first disc 172. The parting means 270 separates the flow of fluid with fluid having less particles entering the third cavity and fluid having more particles entering the collection region 124. Still under the influence of the centrifugal force the particle entrained in fluid in the collection region 124 tend to settle over the first outlet 130. Depending on the operation required the particles by be collected or allowed to exit the separator via the outlet 130 continuously or in batches.

It is noted that in the separator 110′, if the first outlet is closed, the second outlet effectively operated as an open first outlet in the separator 110 and the third outlet of separator 110′ effectively operates as the second outlet of separator 110. In addition collected particles can be removed in batches from the first outlet.

Fluid substantially devoid of particles moves towards the axis of rotation releases rotational energy to the baffles 150 or baffles 272 so that energy is conserved by the separator and fluid exiting the second outlet 128 or third outlet 274 is less turbulent.

The advantages of the present invention will be clear to the skilled addressee. These include:
a screen or filter is not involved and therefore does not need to be cleaned, in effect the separator of the present invention is self cleaning;
the separator need not be operated in a particular orientation, although it may be preferred to use the influence of gravity to assist the fluid moving from the inlet down to the first outlet;
due to the control provided at the first outlet the collection of particles within the collection region need not always by operated in batches, although it may be operated as such;
controlling the outlet of particles from the collection region also assists in better separation and therefore the separator of the present invention is highly efficient; and
energy used to rotate the separator and fluid passing therethough is conserved by recovering the rotational energy imparted on the fluid as it travels through the second sub-cavity.

Modifications and variations may be made to the present invention without departing from the basic inventive concept. Such modifications may include:
altering the method of control of the rate of constituent leaving the first outlet;
altering the orientation of the separator in use;
changing the relative size of the cavity so that it may be shorter and wider (more disc like) or longer and thinner (more cylinder like);
in addition a series of separators may be provided to progressively refine the separation of the outlet of one separator by the operation of a second separator;
the number of baffles/fins may vary to the point where a large number of baffled are provided so that in effect the cavity may become a series of radially extending channels rather than voids with baffles extending therein.

Such modifications and variations are intended to fall within the scope of the present invention, the nature of which is to be determined from the foregoing description.

1. A centrifugal separator for separating separable constituents of a fluid to be separated, including:
a body rotatable about an axis, the body having a cavity therein;
a divider dividing the cavity into a first sub-cavity arranged for fluid to flow in a direction having a radial component and a second sub-cavity arranged for fluid to flow in a direction having a component that is towards the axis of rotation;
an inlet leading into the first sub-cavity at or near the axis of rotation of the body;
a first outlet in communication with a settling region of the cavity between or connecting the first sub-cavity to the second sub-cavity; and
a second outlet leading from the second sub-cavity at or near the axis of rotation of the body;
whereby in use, fluid to be separated enters the cavity via the inlet, rotation of the body and the fluid therein causes a centrifugal force to be applied to fluid flowing through the cavity, a first constituent of the fluid tends to collect in the settling region and a second constituent of the fluid tends to flow into the second sub-cavity, the second constituent in the second sub-cavity exits the cavity via the second outlet and the first constituent collected in the settling region exits the cavity via the first outlet.

2. A centrifugal separator according to claim 1, wherein a third sub-cavity connects the settling region to the first outlet.

3. A centrifugal separator according to claim 2, wherein the third sub-cavity is arranged for fluid flow in a direction having a component that is towards the axis of rotation of the body.

4. A centrifugal separator according to claim 1, wherein the first outlet is at or near the axis of rotation.

5. A centrifugal separator according to claim 2, wherein the third sub-cavity is separated into a plurality of chambers by dividing walls, with each chamber extending towards the axis of rotation.

6. A centrifugal separator according to claim 1, wherein the size of the cavity decreases radially from the axis of rotation.

7. A centrifugal separator according to claim 1, wherein the divider is shaped such that the size of the first sub-cavity increases along the path of flow of fluid though the first sub-cavity.

8. A centrifugal separator according to claim 1, wherein the divider is shaped such that the size of the second sub-cavity decreases along the path of flow of fluid through the second sub-cavity.

9. A centrifugal separator according to claim 1, wherein the divider is shaped to space the first sub-cavity from the second sub-cavity.

10. A centrifugal separator according to claim 1, wherein the first sub-cavity is provided with a plurality of radially extending fins.

11. A centrifugal separator according to claim 10, wherein the first sub-cavity is divided into a plurality of chambers by the fins.

12. A centrifugal separator according to claim 10, wherein the second sub-cavity is provided with a plurality of radially extending second fins.

13. A centrifugal separator according to claim 12, wherein the second sub-cavity is divided into a plurality of chambers by the second fins.

14. A centrifugal separator according to claim 12, wherein each first fin is integrally formed with a corresponding one of the second fins.

15. A centrifugal separator according to claim 1, wherein the separator includes a drive means for rotating the body.

16. A centrifugal separator according to claim 1, wherein the speed of rotation of the body is controlled, whereby the extent of separation of the constituents can be controlled.

17. A centrifugal separator according to claim 1, wherein the separator includes a means for controlling the rate of flow of fluid to be separated in through the inlet.

18. A centrifugal separator according to claim 1, wherein the separator includes a means for controlling the rate of flow of fluid from the first outlet.

19. A centrifugal separator according to claim 1, wherein the separator includes a means for controlling the rate of flow of the fluid from the second outlet.

20. A centrifugal separator according to claim 1, wherein a shaft extends through the axis of rotation, the body arranged to be rotated by rotation of the shaft.

21. A centrifugal separator according to claim 20, wherein the shaft extends through the body.

22. A centrifugal separator according to claim 1, wherein the settling region includes a collection region for holding the collected first constituent until it is removed via the first outlet.

23. A centrifugal separator according to claim 22, wherein the collection region is spaced from the axis of rotation.

24. A centrifugal separator according to claim 1, wherein the body is substantially disc shaped.

25. A centrifugal separator according to claim 1, wherein the body includes a first disc shaped part and a second disc shaped part.

26. A centrifugal separator according to claim 25, wherein the discs are separable.

27. A centrifugal separator according to claim 26, wherein the first outlet is provided by a gap between the body parts when the parts are separated.

28. A centrifugal separator according to claim 27, wherein the size of the gap is adjustable.

29. A centrifugal separator according to claim 24, wherein the divider is in the form of a radially extending planar disc.

30. A centrifugal separator according to claim 29, wherein in one embodiment a circumferential region of the divider includes a first flange extending transversely to a radial line extending from the axis of rotation.

31. A centrifugal separator according to claim 30, wherein the circumferential region includes a second flange extending transversely to the radial line from the axis of rotation and at an angle to the first flange greater than the angle of the first flange to the divider.

32. A centrifugal separator according to claim 1, wherein the inlet is provided with a raceway.

33. A centrifugal separator according to claim 1, wherein the first outlet is provided with a raceway.

34. A centrifugal separator according to claim 1, wherein a separation zone precedes the collection region in the course of flow of fluid.

35. A centrifugal separator according to claim 34, wherein the separation zone is divided into an inner separation zone and an outer separation zone by a parting means.

36. A centrifugal separator according to claim 35, wherein the parting means is a circular knife.

37. A centrifugal separator according to claim 34, wherein the collection region follows the outer separation zone in the course of flow of the fluid.

38. A centrifugal separator according to claim 35, wherein a third outlet leads from the inner separation zone.

39. A centrifugal separator according to claim 27, wherein the first outlet is closed and sealed by a seal in the gap between the parts of the body when the gap between the parts is closed.

40. A centrifugal separator according to claim 27, wherein the first outlet is open when the gap between the parts is opened.
